(19) United States
(12) Patent Application Publication
(10) Pub. No.: US 2008/0133390 A1
(43) Pub. Date: Jun. 5, 2008

(54) System and method for authorizing a transaction

(75) Inventor: German Scipioni, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/633,786

(22) Filed: Dec. 5, 2006

(51) Int. Cl. G06Q 20/00; H04M 1/64

(52) U.S. Cl. 705/35; 379/67.1

(57) ABSTRACT

A system and method of authorizing a transaction includes receiving a transaction request including transaction information. In response to receiving the transaction information, a voice communication session with the user is initiated and a voice message played over the communications session to the user. The voice message includes authentication information. After hearing the voice message, the user is prompted to enter authentication data that is received at an authorization module and if the authentication data matches previously stored authentication data then the transaction is authorized.

### TECHNICAL FIELD

The present application relates generally to authorizing a transaction, and more particularly to systems and methods for authorizing a transaction.

### BACKGROUND

Transactions, for example electronic financial transactions, need to be properly authenticated before being authorized to prevent fraudulent transactions from taking place.

The authentication process needs to be simple for a user whilst not compromising the security of the authentication process.

Therefore what is needed is a system and method which is able to properly authenticate and authorize a transaction whilst at the same time being easy for a user to interact with.

### SUMMARY

According to one embodiment, there is provided a method of authorizing a transaction, the method including:
receiving a transaction request including transaction information;
responsive to receiving the transaction information, initiating a voice communication session with the user;
playing a voice message over the communications session to the user, wherein the voice message includes authentication information;
receiving authentication data from the user; and
authorizing the transaction in response to receiving the authentication data from the user.

According to another embodiment, there is provided a system for authorizing a transaction, the system including:
a communication module to receive transaction information and in response thereto to initiate a voice communication session with the user;
an audio module to play a voice message over the communications session to the user, wherein the voice message includes authentication information; and
an authorization module to receiving authentication data from the user and to authorize the transaction in response to receiving the authentication data.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a diagram of an authorization system, according to an example embodiment.

FIG. 2 is a more detailed diagram of an authorization system, according to an example embodiment.

FIG. 3 is a diagram of a method for authorization a transaction, according to an example embodiment.

FIG. 4 is a diagram of example network-based commerce system or facility which implements various embodiments associated with the invention.

FIG. 5 is a diagram of example applications implemented within some of the components of the network-based commerce system of FIG. 4.

FIG. 6 is a diagram of machine architecture which implements various aspects of the invention, according to an example embodiment.

### DETAILED DESCRIPTION

Methods and systems for authorization transactions are described. In the following description, for purposes of explanation, numerous specific details are set forth in order to provide a thorough understanding of embodiments of the invention. It will be evident, however, to one of ordinary skill in the art that other embodiments of the invention may be practiced without these specific details.

Although the systems and methods relate to authorizing transactions in general, the systems and methods will be described with reference to the transactions being financial transactions, for example a payment from a user to a third party. This payment needs to be authorized before it is processed and the payment effected.

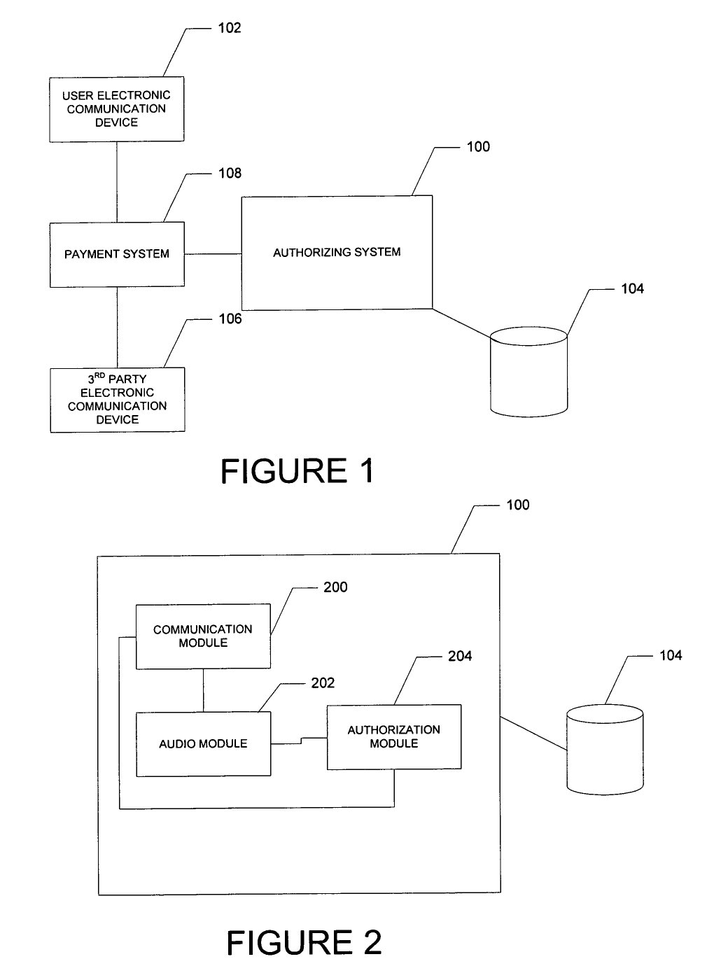

FIG. 1 illustrates an embodiment of an authorization system 100 suitable for implementing example embodiments of the present invention.

A user of an electronic communication device 102 uses the device to connect to a payment system 108 and the authorization system 100 to authorize a payment.

In order to be able to use the payment system 108 and authorization system 100, the user will typically be required to register with the authorization system 100 which will require the user to provide their full names, other personal details and authentication data, for example. In one example embodiment, the authentication data takes the form of a personal identification number (PIN). This will be stored in a database 104 associated with the authorization system 100 along with the user's other information.

When the user wishes to effect a payment to a third party represented by the third-party electronic communication device 106, the user accesses the payment system 108.

The user may access the payment system in any one of a number of ways including sending a short message service (SMS) message to the payment system, sending a multimedia (MMS) message or accessing the payment system via a communication network such as the Internet, to name but a few examples.

It will be appreciated that in certain embodiments, the electronic communication device 102 will be a mobile communications device such as a mobile telephone, for example. If the electronic communication device 102 is a mobile telephone that is used to access the Internet, the device may use the Wireless Application Protocol (WAP), for example.

The example embodiment is not limited to the initiating of the transaction using the electronic communication device 102. The transaction may be initiated by the user using another communication device, such as an automatic teller machine (ATM) belonging to a financial institution or by accessing the payment system via the Internet using a different electronic device, for example. The payment may also be initiated by the user telephoning into an Interactive Voice Response (IVR) of the payment system.

In any event, using an SMS as an illustrative example of initiating a payment, the SMS is sent from the electronic communication device 102 to the payment system 108 via a mobile communications network in the normal manner.

The SMS will need to include transaction information such as details of the third-party payee to whom the payment is being made as well as the amount of the payment.

It will be appreciated that for purposes of the present invention it makes no difference whether the payment is for goods or services rendered or for any other reason such as a transfer of funds between accounts, for example.

The transaction information further includes an identifier of the user. In the example embodiment this is done by identifying the electronic communication device 102 of the user by way of the mobile subscriber ISDN (MSISDN) of the electronic communication device 102.

In response to receiving the payment request including the transaction information, the authorization of the transaction is commenced.

For illustrative purposes, the payment system 108 is shown separate from and connected to the authorization system 100, but it will be appreciated that the authorization system could equally form part of the payment system.

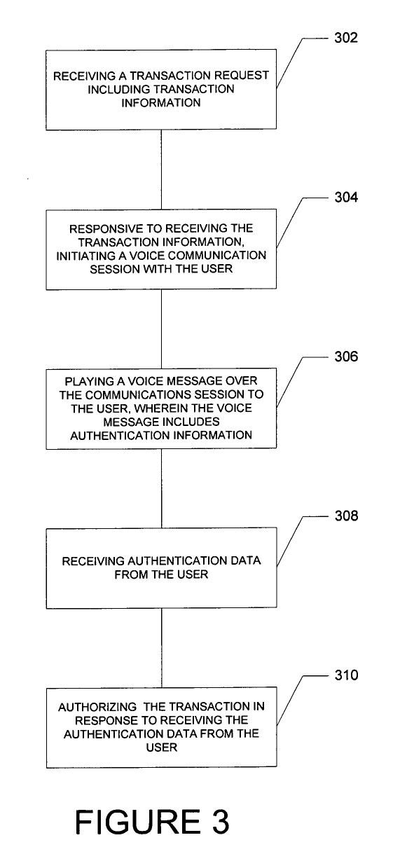

In any event, referring to FIGS. 2 and 3, the transaction information is received by the authorization system (block 302), particularly by way of a communications module 200 of the authorization system 100.

In response to receiving the transaction request, an audio module 202 initiates and voice communications session with the user (block 304).

In an example embodiment, the audio module 202 is an Interactive Voice Response (IVR) server that connects to the electronic communication device 102 via a telephone network.

The audio module 202 plays a voice message over the communication session to the user (block 306), wherein the voice message includes authentication information and in one example at least two pieces of authentication information.

The authentication information in an example embodiment includes an identification of the user such as the name of the user and the amount of the transaction.

In one example embodiment, only the first name of the user is used as the identification of the user. This is advantageous in that in an attempted fraud situation, the last name of the user is not divulged to the fraudster.

An example of the voice message is “Welcome John, kindly confirm your payment of US$ 10”.

It will be appreciated that an advantage of using the amount is that the authentication information changes for each transaction which makes it difficult for a fraudulent transaction to be authorized as if the user does not hear their name and the correct amount they will not send through the authentication data (which will be described below).

On hearing the authentication information, if the user is satisfied that the authentication information is correct, the user will transmit authentication data to the authorization system.

The user will typically be prompted to enter the authentication data by the IVR which may tell the user to “Transmit your personal identification number by SMS to 1234,567 now”, for example.

In an example embodiment the authentication data includes a personal identification number (PIN).

The user could transmit the authentication information in a number of ways, an example of which is to use the electronic device 102 to transmit the information. Where the electronic device 102 is a mobile communication device, the authentication information can be transmitted using the short message service (SMS) protocol, the multimedia (MMS) message protocol or by way of tones that have been keyed into the mobile communications device during the communications session, for example.

Using the SMS protocol as an illustrative example, the user may SMS their PIN to a predetermined number. The SMS will be routed via the mobile communications network to the authorization system 100.

On receiving the SMS (block 308), an authorization module 204 of the authorization system will check that the PIN received matches the stored PIN and if so will authorize the transaction (block 310).

The authorizing of the transaction in an example will be transmitted from the authorization system 100 to the payment system 108 to effect the payment.

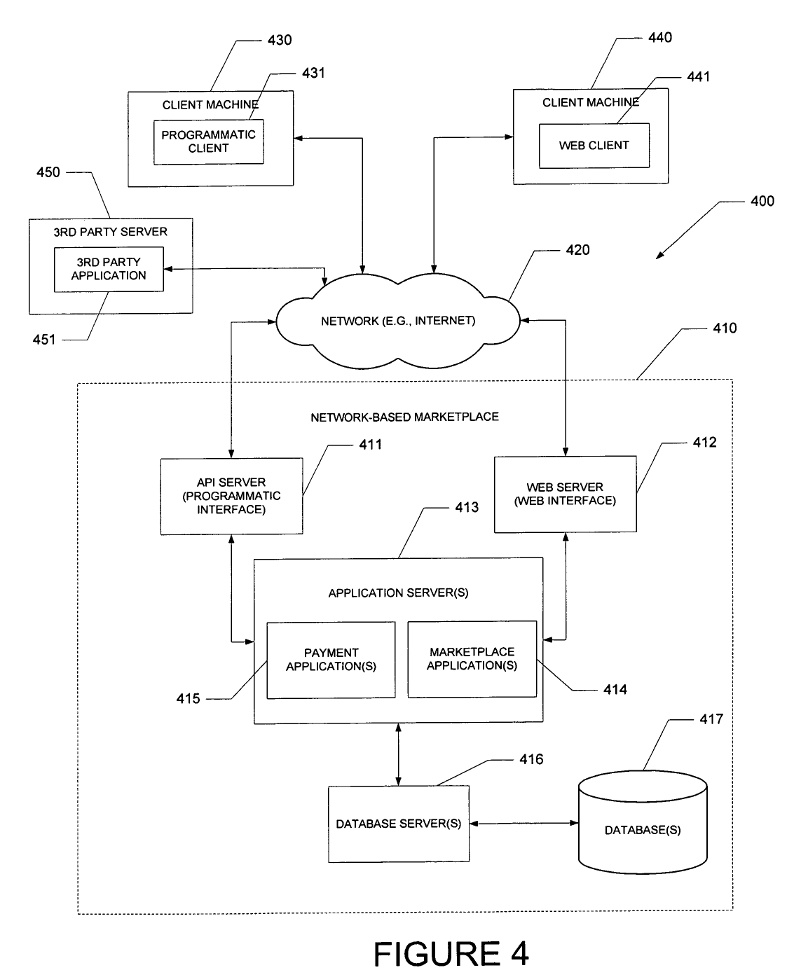

FIG. 4 is a diagram of example network-based commerce system or facility 400 which implements various embodiments associated with the invention. A commerce system 400, in the example form of a network-based marketplace, provides server-side functionality, via a network 420 (e.g., the Internet) to one or more clients.

FIG. 4 illustrates, for example, a web client 441 (e.g., a browser, such as the Internet Explorer browser developed by Microsoft Corporation of Redmond, Wash. State), and a programmatic client 431 executing on respective client machines 440 and 430.

An API server 411 and a web server 412 are coupled to, and provide programmatic and web interfaces respectively to, one or more application servers 413. The application servers 413 host one or more marketplace applications 414 and payment applications 415. The application servers 413 are, in turn, shown to be coupled to one or more databases servers 416 that facilitate access to one or more databases 417. In an example embodiment, the payment system 108 and authorization system 100 form part of the payment applications 415.

The marketplace applications 414 provide a number of marketplace functions and services to users that access the commerce system 410. The payment applications 415 likewise provide a number of payment services and functions to users. The payment applications 415 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 414. While the marketplace and payment applications 414 and 415 are shown in FIG. 4 to both form part of the commerce system 410, it will be appreciated that, in alternative embodiments, the payment applications 415 may form part of a payment service that is separate and distinct from the commerce system 410.

Further, while the system 400 shown in FIG. 4 employs a client-server architecture, the present invention is of course not limited to such an architecture, and could equally well find application in a distributed, or peer-to-peer, architecture system for example. The various marketplace and payment applications 414 and 415 could also be implemented as standalone software programs, which do not necessarily have networking capabilities.

The web client 441 accesses the various marketplace and payment applications 414 and 415 via the web interface supported by the web server 412. Similarly, the programmatic client 431 accesses the various services and functions provided by the marketplace and payment applications 414 and 415 via the programmatic interface provided by the API server 411. The programmatic client 431 may, for example, be a seller application (e.g., the TurboLister application developed by eBay Inc., of San Jose, Calif.) to enable sellers to author and manage listings on the commerce system 410 in an off-line manner, and to perform batch-mode communications between the programmatic client 431 and the network-based commerce system 410.

FIG. 4 also illustrates a third party application 451, executing on a third party server machine 450, as having programmatic access to the network-based commerce system 410 via the programmatic interface provided by the API server 411. For example, the third party application 451 may, utilizing information retrieved from the network-based commerce system 410, support one or more features or functions on a website hosted by the third party. The third party website may, for example, provide one or more promotional, marketplace or payment functions that are supported by the relevant applications of the network-based commerce system 410.

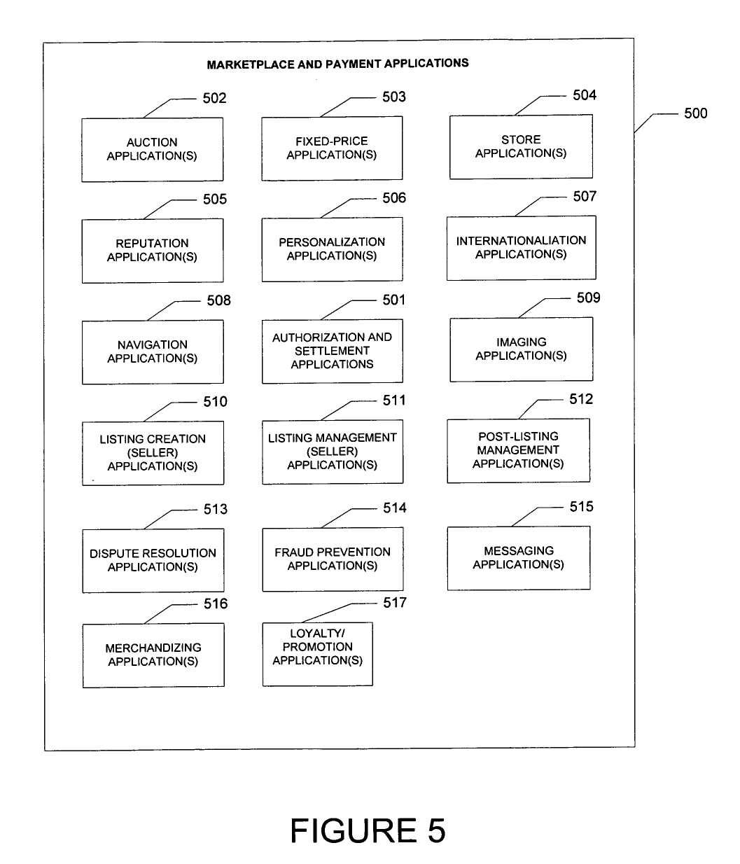

FIG. 5 is a diagram of example applications 500 implemented within some of the marketplace applications 414 of the network-based commerce system 410 of FIG. 4. The applications 500 may be hosted on dedicated or shared server machines (not shown) that are communicatively coupled to enable communications between server machines. The architecture of one such example server machine is provided below. The applications themselves are communicatively coupled (e.g., via appropriate interfaces) to each other and to various data sources, so as to allow information to be passed between the applications or so as to allow the applications to share and access common data.

The authorization and settlement applications 501 provide the novel authorization and settlement services described herein. These applications 501 are coupled or interfaced with a variety of other applications in a commerce system 410.

The commerce system 410 may provide a number of listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 500 are shown to include one or more auction applications 502 which support auction-format listing and price setting mechanisms (e.g., English, Dutch, Vickrey, Chinese, Double, Reverse auctions etc.). The various auction applications 502 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 503 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 504 allow sellers to group their listings within a “virtual” store, which may be branded and otherwise personalized by and for the sellers. Such a virtual store may also offer promotions, incentives and features that are specific and personalized to a relevant seller.

Reputation applications 505 allow parties that transact utilizing the network-based commerce system 410 to establish, build, and maintain reputations, which may be made available and published to potential trading partners. Consider that where, for example, the network-based commerce system 410 supports person-to-person trading, users may have no history or other reference information whereby the trustworthiness and credibility of potential trading partners may be assessed. The reputation applications 505 allow a user, for example through feedback provided by other transaction partners, to establish a reputation within the network-based commerce system 410 over time. Other potential trading partners may then reference such a reputation for the purposes of assessing credibility and trustworthiness.

Personalization applications 506 allow users of the commerce system 410 to personalize various aspects of their interactions with the commerce system 410. For example a user may, utilizing an appropriate personalization application 506, create a personalized reference page at which information regarding transactions to which the user is (or has been) a party may be viewed. Further, a personalization application 506 may enable a user to personalize listings and other aspects of their interactions with the commerce system 410 and other parties.

The network-based commerce system 410 may support a number of marketplaces that are customized, for example, for specific geographic regions. A version of the commerce system 410 may be customized for the United Kingdom, whereas another version of the commerce system 410 may be customized for the United States. Each of these versions may operate as an independent marketplace, or may be customized (or internationalized) presentations of a common underlying marketplace. These are represented as the internationalization applications 507 in FIG. 5.

Navigation of the network-based commerce system 410 may be facilitated by one or more navigation applications 508. For example, a search application enables key word searches of listings published via the commerce system 410. A browse application allows users to browse various category, catalogue, or inventory data structures according to which listings may be classified within the commerce system 410. Various other navigation applications may be provided to supplement the search and browsing applications.

In order to make listings, available via the network-based commerce system 410, as visually informing and attractive as possible, the marketplace applications 500 may include one or more imaging applications 509 utilizing which users may upload images for inclusion within listings. An imaging application 509 also operates to incorporate images within viewed listings. The imaging applications 509 may also support one or more promotional features, such as image galleries that are presented to potential buyers. For example, sellers may pay an additional fee to have an image included within a gallery of images for promoted items.

Listing creation applications 510 allow sellers conveniently to author listings pertaining to goods or services that they wish to transact via the commerce system 410 and listing management applications 511 allow sellers to manage such listings. Specifically, where a particular seller has authored and/or published a large number of listings, the management of such listings may present a challenge. The listing management applications 511 provide a number of features (e.g., auto-re-listing, inventory level monitors, etc.) to assist the seller in managing such listings. One or more post-listing management applications 512 also assist sellers with a number of activities that typically occurs post-listing. For example, upon completion of an auction facilitated by one or more auction applications 502, a seller may wish to leave feedback regarding a particular buyer. To this end, a post-listing management application 512 may provide an interface to one or more reputation applications 505, so as to allow the seller conveniently to provide feedback regarding multiple buyers to the reputation applications 505.

Dispute resolution applications 513 provide mechanisms whereby disputes arising between transacting parties may be resolved. For example, the dispute resolution applications 513 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 514 implement fraud detection and prevention mechanisms to reduce the occurrence of fraud within the commerce system 410.

Messaging applications 515 are responsible for the generation and delivery of messages to users of the network-based commerce system 410, such messages for example advising users regarding the status of listings at the commerce system 410 (e.g., providing “outbid” notices to bidders during an auction process or to provide promotional and merchandising information to users).

Merchandising applications 516 support various merchandising functions that are made available to sellers to enable sellers to increase sales via the commerce system 410. The merchandising applications 516 also operate the various merchandising features that may be invoked by sellers, and may monitor and track the success of merchandising strategies employed by sellers.

The network-based commerce system 410 itself, or one or more parties that transact via the commerce system 410, may operate loyalty programs that are supported by one or more loyalty/promotions applications 517. For example, a buyer may earn loyalty or promotions points for each transaction established and/or concluded with a particular seller, and may be offered a reward for which accumulated loyalty points can be redeemed.

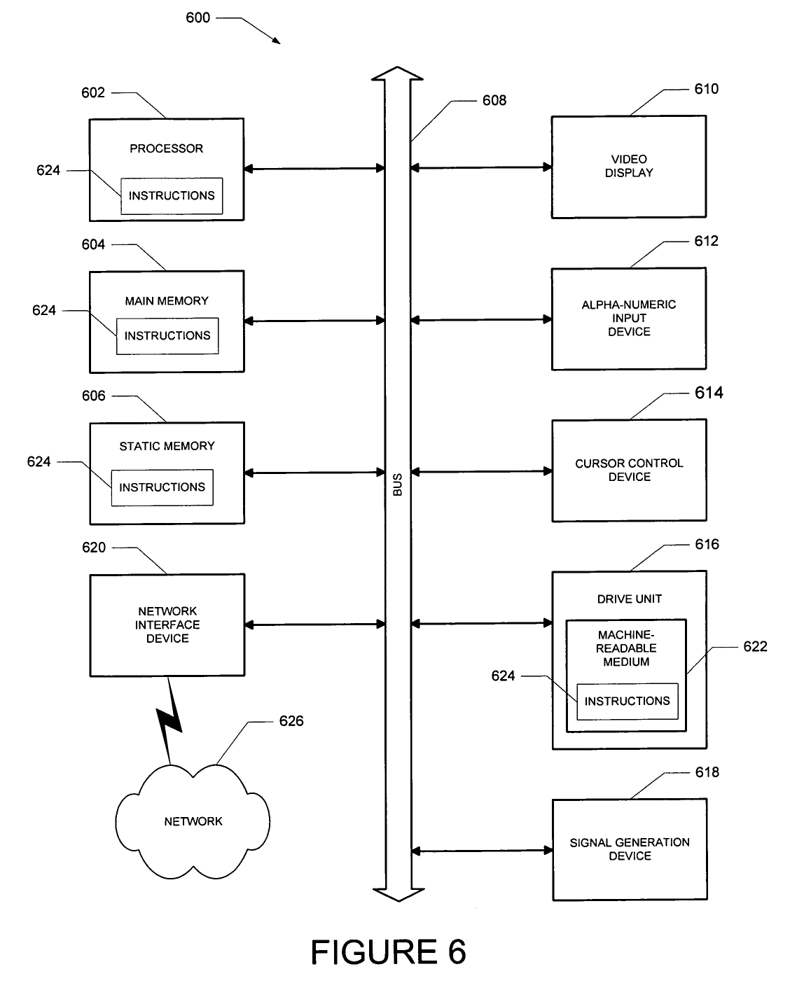

FIG. 6 is a diagram of machine architecture 600 which implements various aspects of the invention, according to an example embodiment. The machine includes a set of instructions, which when executed on the machine cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer architecture 600 includes a processor 602 (e.g., a central processing unit (CPU) a graphics processing unit (GPU) or both), a main memory 604 and a static memory 606, which communicate with each other via a bus 608. The architecture 600 may further include a video display unit 610 (e.g., a liquid crystal display (LCD) or a cathode ray tube (CRT)). The architecture 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the architecture 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to provide novel authorization and settlement have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The above description is illustrative, and not restrictive. Many other embodiments will be apparent to those of ordinary skill in the art upon reviewing the above description. The scope of embodiments should therefore be determined with reference to the appended claims, along with the full scope of equivalents to which such claims are entitled.

1. A method of authorizing a transaction, the method including:
receiving a transaction request including transaction information;
responsive to receiving the transaction information, initiating a voice communication session with the user;
playing a voice message over the communications session to the user, wherein the voice message includes authentication information;
receiving authentication data from the user; and
authorizing the transaction in response to receiving the authentication data from the user.

2. The method of claim 1, wherein the transaction is a payment from the user to another party and the transaction information includes an identity of the user and the amount of the payment.

3. The method of claim 1, wherein the voice communication session with the user is initiated via a telephone network.

4. The method of claim 3, wherein the voice communication session with the user is initiated via a mobile telephone network.

5. The method of claim 2, wherein the authentication information included in the voice message includes at least two pieces of authentication information.

6. The method of claim 5, wherein the two pieces of authentication information are an identification of the user and an amount of the transaction.

7. The method of claim 6, wherein the identification of the user includes a name of the user.

8. The method of claim 7, wherein the name of the user is a first name only of the user.

9. The method of claim 1, wherein the authentication data is received from the user via a telephone communication network.

10. The method of claim 9, wherein the authentication data is received from the user via a mobile telephone communication network.

11. The method of claim 10, wherein the authentication data is received from the user via one of a short message service (SMS) message, a multimedia message (MMS) message or via tones that have been keyed into a telephone of the user during the communication session.

12. The method of claim 1, wherein the authentication data received from the user is compared with authentication data previously stored and the transaction is only authenticated if the received authentication data matches the previously stored authentication data.

13. A system for authorizing a transaction, the system including:
a communication module to receive transaction information and in response thereto to initiate a voice communication session with the user;
an audio module to play a voice message over the communications session to the user, wherein the voice message includes authentication information; and
an authorization module to receive authentication data from the user and to authorize the transaction in response to receiving the authentication data.

14. The system of claim 13 wherein the transaction is a payment from the user to another party and wherein the system further includes a payment system to effect the payment.

15. The system of claim 14 wherein the communication module is to receive transaction information including an identity of the user and the amount of the payment.

16. The system of claim 15, wherein the audio module is to initiate the voice communication session with the user via a telephone network.

17. The system of claim 16, wherein the audio module is to initiate the voice communication session with the user via a mobile telephone network.

18. The system of claim 13, wherein the audio module's voice message includes at least two pieces of authentication information.

19. The system of claim 18, wherein the audio module's voice message includes at least two pieces of authentication information being an identification of the user and an amount of the transaction.

20. The system of claim 19, wherein the audio module's voice message includes an identification of the user being a name of the user.

21. The system of claim 20, wherein the audio module's voice message includes an identification of the user being a first name only of the user.

22. The system of claim 13, wherein the authorization module is to receive authentication data from the user via a telephone communication network.

23. The system of claim 22, wherein the authorization module is to receive authentication data from the user via a mobile telephone communication network.

24. The system of claim 23, wherein the authorization module is to receive the authentication data from the user via one of a short message service (SMS) message, a multimedia message (MMS) message or via tones that have been keyed into a telephone of the user during the communication session.

25. The system of claim 13, wherein the authorization module is to compare authentication data received from the user with authentication data previously stored and the transaction is only authenticated if the received authentication data matches the previously stored authentication data.

26. A machine-readable medium comprising instructions, which when executed by a machine, cause the machine to perform a method of authorizing a transaction, the instructions including:
first instructions to receive a transaction request including transaction information;
second instructions, responsive to receiving the transaction information, to initiate a voice communication session with the user;
third instructions to play a voice message over the communications session to the user, wherein the voice message includes authentication information;
fourth instructions to receive authentication data from the user; and
firth instructions to authorize the transaction in response to receiving the authentication data from the user.
